(19) United States
(12) Patent Application Publication
(10) Pub. No.: US 2019/0284353 A1
(43) Pub. Date: Sep. 19, 2019

(54) COEFFICIENT OF FRICTION IMPROVEMENT IN PACKAGING MATERIALS

(71) Applicant: KIMBERLY-CLARK WORLDWIDE, INC., Neenah, WI (US)

(72) Inventors: Brent M. THOMPSON, Oshkosh, WI (US); Gregory J. WIDEMAN, Menasha, WI (US); Thomas G. SHANNON, Neenah, WI (US)

(73) Assignee: Kimberly-Clark Worldwide, Inc., Neenah, WI (US)

(21) Appl. No.: 16/301,609

(22) PCT Filed: May 31, 2016
(86) PCT No.: PCT/US16/35033

§ 371 Date: Nov. 14, 2018

(51) Int. Cl. C08J 5/18; B32B 27/08; B32B 27/32; C08J 5/20; C08K 5/20; C08K 9/04; C08L 23/06

(52) U.S. Cl. CPC C08J 5/18; B32B 27/08; B32B 27/32; C08J 5/20; B32B 2475/00; C08K 9/04; C08L 23/06; C08J 2323/06; C08K 5/20

(57) ABSTRACT

A film includes a polymer composition, the polymer composition including a polymer, an organoclay, a primary amide slip agent, and a secondary amide slip agent different from the primary amide slip agent. The film can have static and kinetic coefficients of friction less than 0.25 as measured using ASTM D1894. The primary amide slip agent can be a primary erucamide slip agent. The film can be a multi-layered film.

### BACKGROUND

Slip agents are a group of film surface modifiers (fatty acid amides) used as an additive to flexible films to lower their inherent surface COF (coefficient of friction). Slip agents reduce the friction or drag force on the rollers and belts of the filling or bag making equipment. Slip agents are also used in conjunction with other materials to reduce blocking force, or the tendency of two thin film layers to mechanically bond or stick together, which can lead to tears or other visual impairments in film as it is unrolled.

Current slip agent solutions include a standard primary eurucamide slip agent such as AMPACET 10090 brand slip agent used with standard polyethylene film to obtain the desired surface COF. Advanced packaging solutions, however, such as those including organoclays, can lead to an increased COF that cannot be addressed by current slip agent solutions. Because COF is a critical attribute of flexible packaging bags, this problem needs to be solved to proceed with advanced packaging solutions.

As such, a need currently exists for improved packaging materials that can maintain a sufficiently low coefficient of friction.

### SUMMARY

With organoclay films, adding more primary erucamide slip agent becomes limited in effectiveness and another solution is needed to obtain a COF below 0.25 along with maintaining or improving other desired standard physical properties. By adding a unique combination of slip agents, the problem described above was overcome by achieving COFs consistently below 0.25.

In accordance with one aspect of the present disclosure, a film includes a polymer composition, the polymer composition including a polymer, an organoclay, a primary amide slip agent, and a secondary amide slip agent different from the primary amide slip agent.

In another aspect of the present disclosure, a film includes a polymer composition, the polymer composition including a polymer, an organoclay, a primary amide slip agent, and a secondary amide slip agent, wherein the film has static and kinetic coefficients of friction less than 0.25 as measured using ASTM D1894.

In still another aspect of the present disclosure, a film includes a polymer composition, the polymer composition including a polymer, an organoclay, a primary erucamide slip agent, and a secondary amide slip agent.

Other features and aspects of the present disclosure are described in more detail below.

### DETAILED DESCRIPTION

Reference now will be made in detail to various aspects of the disclosure, one or more examples of which are set forth below. Each example is provided by way of explanation, not limitation of the disclosure. In fact, it will be apparent to those skilled in the art that various modifications and variations can be made in the present disclosure without departing from the scope or spirit of the disclosure. For instance, features illustrated or described as part of one aspect, can be used on another aspect to yield a still further aspect. Thus, it is intended that the present disclosure cover such modifications and variations.

Generally speaking, the present disclosure is directed to film materials used to form packaging that is subsequently filled with a product. The film material includes a polymer composition containing at least one polymer and at least one nanofiller. Experimentation has revealed that through selective control over the particular type and concentration of these components, as well as the manner in which the film is formed, the resulting packaging materials can maintain a sufficiently low coefficient of friction (COF) to allow the efficient handling and filling of such packages.

A slip agent is plastics additive that essentially acts as a lubricant to reduce friction, for example, on the surface of a film. Many polyolefins are naturally tacky. A slip agent aids in the processability of the polyolefin be reducing the tendency of polyolefin to stick to machinery and itself. The effectiveness of slip additive is typically determined by the COF it allows, which is measured using ASTM D1894, “Standard Test Method for Static and Kinetic Coefficients of Friction of Plastic Film and Sheeting.” Basically, static COF is a measure of the resistance to overcome to start an object sliding, and kinetic COF is a measure of the resistance to overcome to keep an object sliding. For the purposes of this specification, both static COF and kinetic COF need to be less than 0.25. COF is a unit-less ratio of the force required to slide one layer of film across another relative to the force exerted on it.

The terms “primary” and “secondary” in reference to an amide slip agent refer to the amide position on different backbones, not to the status or importance of the amide slip agent. There is never a reason to combine primary and secondary amide slip agents because secondary amide slip agents are much more expensive than primary amide slip agents, and it is expected that the use of secondary amide slip agents would result in the COF remaining high.

Slip agents are a group of film surface modifiers (fatty acid amides) used to lower the inherent surface COF as an additive to flexible films. The slip agent moves or blooms to the surface due to solubility differences with the base polymers, resulting in reduced friction or drag force on the rollers and belts of the filling or bag making equipment. It is also used in conjunction with other materials to reduce blocking force, or the tendency of two thin film layers to mechanically bond or stick together, which can lead to tears or other visual impairments in the film as it is unrolled. Slip bloom is critical to both bag-filling and bag-making operations.

The most common slip agents used for polyolefins are long-chain fatty acid amides, with amides from oleyl (single unsaturated C−18) through erucyl (C−22 single unsaturated) being used. Slip agents have a natural tendency to bloom to the surface of a film over time after extrusion. Different slip agents have different rates of surface bloom and COF reduction.

It is known that high amounts of any slip agent make surface treatments difficult, and can interfere with printability and sealability.

Organoclay, when used as an additive in packaging applications, significantly impacts the surface COF, rendering the resultant bags unusable as they will not fill correctly on automated equipment.

The addition of organoclay to thin, flexible films also provides numerous benefits. However, as mentioned above, organoclay interferes with the final surface COF by disrupting the normal slip bloom to the surface of the structure. By disrupting slip bloom, resulting film COFs are higher than expected. High COF film will not process and fill correctly on automated bag filling equipment.

COF being a critical attribute of flexible packaging bags, this problem needed to be solved to proceed with organoclay gauge reduction trials. By adding a unique combination of slip agents, the problem described above was overcome by achieving COFs consistently below 0.25.

Using a primary amide slip agent in film is known. The standard primary amide slip agent is insufficient to provide the needed COF with specialty organoclay nanocomposite films, even at addition rates at the high-end addition limit. Use of a secondary amide slip agent alone is also insufficient. Combining these two types of slip agents, however, surprisingly provided a synergistic effect and produced the needed COF. Not to be limited by theory, it is believed the primary slip agent migrates to the clay/polymer interface, which has a high surface area due to nanosized clay, allowing the secondary amide slip agent to migrate to and remain at the outer surfaces of the film. This is an important effect that is needed to commercialize the use of these organoclay nanocomposite films as packaging films for products.

This disclosure describes the use of secondary amide slip concentrates (e.g., AMPACET 102109 brand slip agent), as well as a primary amide slip agent, in an organoclay (nanocomposite) flexible polyethylene film to obtain the desired surface slip properties including COF.

One beneficial aspect of the present disclosure is that the low coefficient of friction can be provided without the need for additional layers or materials that might otherwise impact the handling, printing, forming, filling, and sealing of the packaging material and packages. Nevertheless, due to the unique structure of the packaging materials and the manner in which the packaging materials are formed, the film of the present disclosure can still maintain good mechanical properties, such as a high ductility.

One parameter that is indicative of good ductility is the peak elongation of the film in the machine direction (“MD”) and/or cross-machine direction (“CD”). For example, the film can typically exhibit a peak elongation in the machine direction of about 400% or more, in some aspects about 500% or more, in some aspects about 550% or more, and in some aspects, from about 600% to about 2000%. The film can likewise exhibit a peak elongation in the cross-machine direction of about 750% or more, in some aspects about 800% or more, in some aspects about 800% or more, and in some aspects, from about 850% to about 2500%. Despite having such good ductility, the film of the present disclosure is nevertheless able to retain good mechanical strength. For example, the film of the present disclosure can exhibit an ultimate tensile strength in the machine direction and/or cross-machine direction of from about 20 to about 150 Megapascals (MPa), in some aspects from about 25 to about 100 MPa, and in some aspects, from about 30 to about 80 MPa. The Young's modulus of elasticity of the film, which is equal to the ratio of the tensile stress to the tensile strain and is determined from the slope of a stress-strain curve, can also be shown to improve. For example, the film typically exhibits a Young's modulus in the machine direction and/or cross-machine direction of from about 50 to about 500 MPa, in some aspects from about 100 to about 400 MPa, and in some aspects, from about 150 to about 350 MPa.

Surprisingly, the good ductility and other mechanical properties can be achieved even though the film has a very low thickness. In this regard, the normalized mechanical properties, which are determined by dividing a particular mechanical value (e.g., Young's modulus, tensile strength, or peak elongation) by the average film thickness (μm), can also be improved. For example, the film can exhibit a normalized peak elongation in the machine direction of about 30%/μm or more, in some aspects about 40%/μm or more, and in some aspects, from about 50%/μm to about 150%/μm. The film can likewise exhibit a normalized peak elongation in the cross-machine direction of about 40%/μm or more, in some aspects about 50%/μm or more, and in some aspects, from about 60%/μm to about 200%/μm. The film can exhibit a normalized ultimate tensile strength in the machine direction and/or cross-machine direction of from about 0.5 to about 20 MPa/μm, in some aspects from about 1 to about 12 MPa/μm, and in some aspects, from about 2 to about 8 MPa/μm. The normalized Young's modulus in the machine direction and/or cross-machine direction can also be from about 5 to about 50 MPa/μm, in some aspects from about 10 to about 40 MPa/μm, and in some aspects, from about 15 to about 35 MPa/μm.

In various aspects of the present disclosure, the film of the present disclosure includes at least one layer including a polymer composition. Other layers can be added as described below, and multiple components can be employed. Various aspects of the present disclosure will now be described in more detail.

### I. Polymer Composition

### A. Polyolefin

Any suitable polymer can be used in the formation of the polymer composition. Different polyolefins, however, would require the use of different carrier resins. In one particular aspect of the present disclosure, ethylene polymer is used. Ethylene polymers typically constitute from about 80 wt. % to about 99.9 wt. %, in some aspects from about 90 wt. % to about 99.5 wt. %, and in some aspects, from about 95 wt. % to 98 wt. % of the polymer content of the polymer composition. Likewise, ethylene polymers can constitute from about 75 wt. % to about 99 wt. %, in some aspects from about 80 wt. % to about 98 wt. %, and in some aspects, from about 85 wt. % to 95 wt. % of the entire polymer composition.

Any of a variety of ethylene polymers can generally be employed in the present disclosure. In one aspect, for instance, the ethylene polymer can be a copolymer of ethylene and an α-olefin, such as a C₃-C₂₀ α-olefin or C₃-C₁₂ α-olefin. Suitable α-olefins can be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers can be from about 60 mole % to about 99 mole %, in some aspects from about 80 mole % to about 98.5 mole %, and in some aspects, from about 87 mole % to about 97.5 mole %. The α-olefin content can likewise range from about 1 mole % to about 40 mole %, in some aspects from about 1.5 mole % to about 15 mole %, and in some aspects, from about 2.5 mole % to about 13 mole %. The density of the polyethylene can vary depending on the type of polymer employed, but generally ranges from about 0.85 to about 0.96 grams per cubic centimeter (g/cm³). Polyethylene “plastomers”, for instance, can have a density in the range of from about 0.85 to about 0.91 g/cm³. Likewise, “linear low density polyethylene” (LLDPE) can have a density in the range of from about 0.91 to about 0.940 g/cm³; “low density polyethylene” (LDPE) can have a density in the range of from about 0.910 to about 0.940 g/cm³; and “high density polyethylene” (HDPE) can have density in the range of from about 0.940 to about 0.960 g/cm³, such as determined in accordance with ASTM D792.

In certain aspects, an ethylene polymer can be employed that has a relatively low density in the range of about 0.94 g/cm³ or less, in some aspects from about 0.85 to about 0.94 g/cm³, and in some aspects, from about 0.90 to about 0.935 g/cm³. One or more polymers can be employed in the composition that has these density characteristics. Linear low density polyethylene (“LLDPE”) and/or low density polyethylene (“LDPE”) are particularly suitable. The low density ethylene polymer can have a relatively low melting temperature and modulus of elasticity, which can provide the resulting film with a relatively soft and ductile feel. For example, the low density ethylene polymer can have a melting temperature of from about 50° C. to about 145° C., in some aspects from about 75° C. to about 140° C., and in some aspects, from about 100° C. to about 135° C., and a modulus of elasticity of from about 50 to about 700 MPa, in some aspects from about 75 to about 600 MPa, and in some aspects, from about 100 to about 500 MPa, as determined in accordance with ASTM D638-10. The low density ethylene polymer can also have a melt flow index of from about 0.1 to about 100 grams per 10 minutes, in some aspects from about 0.5 to about 50 grams per 10 minutes, and in some aspects, from about 1 to about 40 grams per 10 minutes, determined at a load of 2160 grams and at 190° C., as determined in accordance with ASTM D1238-13 (or ISO 1133).

If desired, low density ethylene polymers can constitute a substantial majority of the polymers employed in the composition. For example, low density ethylene polymers can constitute about 80 wt. % or more, in some aspects about 85 wt. % or more, and in some aspects, from about 90 wt. % to 100 wt. % of the polymers employed in the composition. Of course, in other aspects, high density ethylene polymers can also be employed. For example, low density ethylene polymers can constitute from about 5 wt. % to about 90 wt. %, in some aspects from about 10 wt. % to about 80 wt. %, and in some aspects, from about 20 wt. % to 70 wt. % of the polymer composition and high density ethylene polymers can constitute from about 5 wt. % to about 90 wt. %, in some aspects from about 10 wt. % to about 80 wt. %, and in some aspects, from about 20 wt. % to 70 wt. % of the polymer composition.

The high density ethylene polymers typically have a density of greater than about 0.94 g/cm³, in some aspects from about 0.945 to about 0.98 g/cm³, and in some aspects, from about 0.95 to about 0.97 g/cm³. Once again, one or more polymers can be employed in the composition that has these characteristics. High density polyethylene (“HDPE”) is particularly suitable. The high density ethylene polymers can have a relatively low melting temperature and high modulus of elasticity. For example, the high density ethylene polymers can have a melting temperature of from about 70° C. to about 160° C., in some aspects from about 85° C. to about 150° C., and in some aspects, from about 110° C. to about 145° C., and a modulus of elasticity of from about 700 to about 5,000 MPa, in some aspects from about 750 to about 3,000 MPa, and in some aspects, from about 1,000 to about 2,000 MPa, as determined in accordance with ASTM D638-10. The high density ethylene polymers can also have a melt flow index of from about 0.1 to about 100 grams per 10 minutes, in some aspects from about 0.5 to about 50 grams per 10 minutes, and in some aspects, from about 1 to about 40 grams per 10 minutes, determined at a load of 2160 grams and at 190° C., as determined in accordance with ASTM D1238-13 (or ISO 1133).

### B. Nanofiller

The nanofiller employed in the polymer composition typically has an average cross-sectional dimension (e.g., thickness or diameter) of from about 0.2 to about 100 nanometers, in some aspects from about 0.5 to about 50 nanometers, and in some aspects, from about 1 to about 20 nanometers. For example, the nanofiller can have a flake-like morphology in that it possesses a relatively flat or platelet shape. The platelets can, for example, have an average thickness within the ranges noted above. The “aspect ratio” of the platelets (i.e., the average length of the platelets divided by the average thickness) can also be relatively large, such as from about 20 to about 1000, in some aspects from about 50 to about 80, in some aspects, from about 100 to about 400. The average length (e.g., diameter) can, for instance, range from about 20 nanometers to about 10 micrometers, in some aspects from about 100 nanometers to about 5 micrometers, and in some aspects, from about 200 nanometers to about 4 micrometers.

The material used for the nanofiller can be any suitable nanoclay/organoclay. Nanoclays are particularly suitable for use in the present disclosure. The terms “nanoclay” and “organoclay” are synonymous and generally refer to nanoparticles of a clay material (a naturally occurring mineral, an organically modified mineral, or a synthetic nanomaterial). The clay material can be formed from a phyllosilicate, such as a smectite clay mineral (e.g., bentonite, kaolinite, or montmorillonite, as well as salts thereof, such as sodium montmorillonite, magnesium montmorillonite, calcium montmorillonite, etc.); nontronite; beidellite; volkonskoite; hectorite; saponite; sauconite; sobockite; stevensite; svinfordite; vermiculite; etc. Other useful nanoclays include micaceous minerals (e.g., illite) and mixed illite/smectite minerals, such as rectorite, tarosovite, ledikite and admixtures of illites with the clay minerals named above. Particularly suitable are montmorillonite (2:1 layered smectite clay structure), bentonite (aluminium phyllosilicate formed primarily of montmorillonite), kaolinite (1:1 aluminosilicate having a platy structure and empirical formula of Al₂Si₂O₅(OH)₄), halloysite (1:1 aluminosilicate having a tubular structure and empirical formula of Al₂Si₂O₅(OH)₄), etc.

If desired, the nanofiller can contain an organic surface treatment that enhances the hydrophobicity of the nanofiller. Without intending to be limited by theory, it is believed that the organic surface treatment can have a plastifying-like effect on the nanofiller that can increase the compatibility between polyolefin and nanofiller and also reduce the degree of agglomeration of surface friction between the nanofiller phase and domains of the ethylene polymer when the composition is subjected to an elongational force. The surface treatment can also have a lubricating effect that allows the macromolecular chains of the ethylene polymer to slip along the nanofiller surface without causing debonding.

In one aspect, the organic surface treatment can be formed from a quaternary onium (e.g., salt or ion), which can become intercalated via ion-exchange into the interlayer spaces between adjacent layered platelets. The quaternary onium ion can have the following structure:

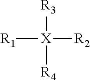

wherein X is N, P, S, or O; and R₁, R₂, R₃ and R₄ are independently hydrogen or organic moieties, such as linear or branched alkyl, aryl or aralkyl moieties having 1 to about 24 carbon atoms.

Particularly suitable quaternary ammonium ions are those having the structure below:

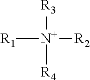

wherein R₁ is a long chain alkyl moiety ranging from C₆ to C₂₄, straight or branched chain, including mixtures of long chain moieties, such as C₆, C₈, C₁₀, C₁₂, C₁₄, C₁₆, C₁₈, C₂₀, C₂₂ and C₂₄, alone or in any combination; and R₂, R₃ and R₄ are moieties, which can be the same or different, selected from the group consisting of H, alkyl, hydroxyalkyl, benzyl, substituted benzyl, e.g., straight or branched chain alkyl-substituted and halogen-substituted; ethoxylated or propoxylated alkyl; ethoxylated or propoxylated benzyl (e.g., 1-10 moles of ethoxylation or 1-10 moles of propoxylation).

Additional useful multi-charged spacing/coupling agents include for example, tetra-, tri-, and di-onium species such as tetra-ammonium, tri-ammonium, and di-ammonium (primary, secondary, tertiary, and quaternary), -phosphonium, -oxonium, or -sulfonium derivatives of aliphatic, aromatic or arylaliphatic amines, phosphines, esters, alcohols and sulfides. Illustrative of such materials are di-onium compounds of the formula:

R¹—X⁺—R—Y⁺

where X⁺ and Y⁺, are the same or different, and are ammonium, sulfonium, phosphonium, or oxonium radicals such as —NH(CH₃)₂⁺, —NH₂(CH₃)⁺, —N(CH₃)₃⁺, —N(CH₃)₂(CH₂CH₃)⁺, —N(CH₃)(CH₂CH₃)₂⁺, —S(CH₃)₂⁺, —S(CH₃)₂⁺, —P(CH₃)₃⁺, —NH₃⁺, etc.; R is an organic spacing, backbone radical, straight or branched, such as those having from 2 to 24 carbon atoms, and in some aspects from 3 to 10 carbon atoms, in a backbone organic spacing molecule covalently bonded at its ends to charged N⁺, P⁺, S⁺ and/or O⁺ cations; R¹ can be hydrogen, or a linear or branched alkyl radical of 1 to 22 carbon atoms, linear or branched, and in some aspects, 6 to 22 carbon atoms.

Illustrative of useful R groups are alkyls (e.g., methyl, ethyl, butyl, octyl, etc.); aryl (e.g., benzyl, phenylalkyl, etc.); alkylenes (e.g., methylene, ethylene, octylene, nonylene, tert-butylene, neopentylene, isopropylene, sec-butylene, dodecylene, etc.); alkenylenes (e.g., 1-propenylene, 1-butenylene, 1-pentenylene, 1-hexenylene, 1-heptenylene, 1-octenylene, etc.); cycloalkenylenes (e.g., cyclohexenylene, cyclopentenylene, etc.); hydroxyalkyl (e.g., hydroxymethyl, hydroxyethyl, hydroxyl-n-propyl, hydroxyisopropyl, hydroxyl-n-butyl, hydroxyl-iso-butyl, hydroxyl-tert-butyl, etc.), alkanoylalkylenes (e.g., butanoyl octadecylene, pentanoyl nonadecylene, octanoyl pentadecylene, ethanoyl undecylene, propanoyl hexadecylene, etc.); alkylaminoalkylenes (e.g., methylamino octadecylene, ethylamino pentadecylene, butylamino nonadecylene, etc.); dialkylaminoalkylene (e.g., dimethylamino octadecylene, methylethylamino nonadecylene, etc.); arylaminoalkylenes (e.g., phenylamino octadecylene, α-methylphenylamino nonadecylene, etc.); diarylaminoalkylenes (e.g., diphenylamino pentadecylene, p-nitrophenyl-α′-methylphenylamino octadecylene, etc.); alkylarylaminoalkylenes (e.g., 2-phenyl-4-methylamino pentadecylene, etc.); alkylsulfinylenes, alkylsulfonylenes, alkylthio, arylthio, arylsulfinylenes, and arylsulfonylenes (e.g., butylthio octadecylene, neopentylthio pentadecylene, methylsulfinylnonadecylene, benzylsulfinyl pentadecylene, phenylsulfinyl octadecylene, propylthiooctadecylene, octylthio pentadecylene, nonylsulfonyl nonadecylene, octylsulfonyl hexadecylene, methylthio nonadecylene, isopropylthio octadecylene, phenylsulfonyl pentadecylene, methylsulfonyl nonadecylene, nonylthio pentadecylene, phenylthio octadecylene, ethyltio nonadecylene, benzylthio undecylene, phenethylthio pentadecylene, sec-butylthio octadecylene, naphthylthio undecylene, etc.); alkoxycarbonylalkylenes (e.g., methoxycarbonylene, ethoxycarbonylene, butoxycarbonylene, etc.); cycloalkylenes (e.g., cyclohexylene, cyclopentylene, cyclooctylene, cycloheptylene, etc.); alkoxyalkylenes (e.g., methoxymethylene, ethoxymethylene, butoxymethylene, propoxyethylene, pentoxybutylene, etc.); aryloxyalkylenes and aryloxyarylenes (e.g., phenoxyphenylene, phenoxymethylene, etc.); aryloryalkylenes (e.g., phenoxydecylene, phenoxyoctylene, etc.); arylalkylenes (e.g., benzylene, phenthylene, 8-phenyloctylene, 10-phenyldecylene, etc.); alkylarylenes (e.g., 3-decylphenylene, 4-octylphenylene, 4-nonylphenylene, etc.); and polypropylene glycol and polyethylene glycol substituents (e.g., ethylene, propylene, butylene, phenylene, benzylene, tolylene, α-styrylene, α-phenylmethylene, octylene, dodecylene, octadecylene, methoxyethylene, etc.), as well as combinations thereof. Such tetra-, tri-, and di-ammonium, -sulfonium, -phosphonium, -oxonium; ammonium/sulfonium; ammonium/phosphonium; ammonium/oxonium; phosphonium/oxonium; sulfonium/oxonium; and sulfonium/phosphonium radicals are well known in the art and can be derived from the corresponding amines, phosphines, alcohols or ethers, and sulfides.

Particularly suitable multi-charged spacing/coupling agent compounds are multi-onium ion compounds that include at least two primary, secondary, tertiary or quaternary ammonium, phosphonium, sulfonium, and/or oxonium ions having the following general formula:

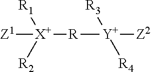

wherein R is an alkylene, aralkylene or substituted alkylene charged atom spacing moiety; and Z₁, Z₂, R₁, R₂, R₃, and R₄ can be the same or different and selected from the group consisting of hydrogen, alkyl, aralkyl, benzyl, substituted benzyl (e.g., straight or branched chain alkyl-substituted and halogen-substituted); ethoxylated or propoxylated alkyl; ethoxylated or propoxylated benzyl (e.g., 1-10 moles of ethoxylation or 1-10 moles of propoxylation).

Particularly suitable organic cations can include, for instance, quaternary ammonium compounds, such as dimethyl bis[hydrogenated tallow] ammonium chloride (2M2HT), methyl benzyl bis[hydrogenated tallow] ammonium chloride (MB2HT), methyl tris[hydrogenated tallow alkyl] chloride (M3HT), etc. One example of a suitable nanofiller with such a surface treatment is NANOMER 1.44P, which is a quaternary ammonium modified montmorillonite nanoclay and commercially available from Nanocor, Inc. Other suitable nanoclay additives include those available from Southern Clay Products, such as CLOISITE 15A, CLOISITE 30B, CLOISITE 93A, and CLOISITE Na⁺.

The onium ion can be introduced into (sorbed within) the interlayer spaces of the nanofiller in a number of ways. In one method, for example, the nanofiller is slurried in water, and the onium ion compound is dissolved therein. If necessary, the onium ion compound can be dissolved first in an organic solvent (e.g., propanol). If desired, the nanofiller can also be intercalated with an oligomer and/or polymer intercalant as is known in the art. For example, an olefin polymer or oligomer (e.g., ethylene polymer) intercalant can be employed. To intercalate an onium ion and an olefin intercalant between adjacent phyllosilicate platelets and optionally separate (exfoliate) the layered material into individual platelets, for example, the nanofiller can be first contacted with the onium ion and simultaneously or thereafter contacted with the melted oligomer/polymer intercalant to the onium ion-intercalated layered material. This can be accomplished, for instance, by directly compounding the materials in an extruder. Alternatively, the oligomer/polymer can be intercalated by an emulsion process by vigorously mixing with an emulsifier. If desired, a coupling agent (e.g., silane coupling agent) can also be employed to help bond the intercalant with the clay material. For example, the nanofiller can be initially treated with a coupling agent followed by ion-exchange of onium ions between the nanofiller, prior to or simultaneously with intercalation of the oligomer(s) or polymer(s). It should be understood that the oligomer or polymer intercalant(s) can also be intercalated between and complexed to the internal platelet faces by other well-known mechanisms, such as by dipole/dipole bonding (direct intercalation of the oligomer or polymer) as described in U.S. Pat. Nos. 5,880,197 and 5,877,248, as well as by acidification with substitution with hydrogen (ion-exchanging the interlayer cations with hydrogen by use of an acid or ion-exchange resin) as described in U.S. Pat. Nos. 5,102,948 and 5,853,886.

Nanofillers typically constitute from about 0.5 wt. % to about 20 wt. %, in some aspects from about 1 wt. % to about 15 wt. %, and in some aspects, from about 2 wt. % to about 10 wt. % of the polymer composition.

### C. Slip Agents

A lack of slip blooming in polyolefins with nanofillers was unexpectedly a concern. The addition of standard erucamide slip agents to organoclay films yielded test films with COFs above currently-desired COF specification maximums. It was determined through trial work that the primary amide slip agents even at high loadings of primary amide slip agent were not effective in reducing the COFs of the packaging film below 0.25 for either static or kinetic COF. As a result, these COFs were deemed unacceptable by packaging engineers as being too high for optimal filling and sealing.

Further experimentation found that a combination of a secondary and primary amide slip agents provides a synergistic reduction in COF when using organoclay-containing packaging films. Conventional films currently use only primary amide slip agents due to their wide use in the industry, effectiveness, cost, and availability. Also, the primary amide slip agents' resultant COFs are well known and understood.

The best result was determined through experimentation to be a combination of a secondary amide slip agent and a primary amide slip agent. The secondary amide slip blooms to the surface more slowly than the primary agent, but also settles and maintains its position on the surface of the film.

### D. Compatibilizer

Although not necessarily required, a compatibilizer can also be employed in the polymer composition, such as in an amount of from about 0.1 wt. % to about 10 wt. %, in some aspects from about 0.2 wt. % to about 8 wt. %, and in some aspects, from about 0.5 wt. % to about 5 wt. % of the polymer composition. The compatibilizer can be a polyolefin containing an olefin component and a polar component. The olefin component is non-polar and thus generally has an affinity for the ethylene polymer. The olefin component can generally be formed from any linear or branched α-olefin monomer, oligomer, or polymer (including copolymers) derived from an α-olefin monomer. In one particular aspect, for example, the compatibilizer includes at least one linear or branched α-olefin monomer, such as those having from 2 to 20 carbon atoms and preferably from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin co-monomers are ethylene and propylene.

The polyolefin compatibilizer is also functionalized with a polar component, which can be grafted onto the polymer, incorporated as a monomeric constituent of the polymer (e.g., block or random copolymers), etc. When grafted onto a polymer backbone, particularly suitable polar groups are maleic anhydride, maleic acid, acrylic acid, methacrylic acid, fumaric acid, maleimide, maleic acid hydrazide, a reaction product of maleic anhydride and diamine, methylnadic anhydride, dichloromaleic anhydride, maleic acid amide, etc. Maleic anhydride modified polyolefins are particularly suitable for use in the present disclosure. Such modified polyolefins are typically formed by grafting maleic anhydride onto a polymeric backbone material. Such maleated polyolefins are available from E. I. du Pont de Nemours and Company under the designation FUSABOND, such as the α Series (chemically modified polypropylene), E Series (chemically modified polyethylene), C Series (chemically modified ethylene vinyl acetate), A Series (chemically modified ethylene acrylate copolymers or terpolymers), M Series (chemically modified polyethylene), or N Series (chemically modified ethylene-propylene, ethylene-propylene diene monomer (“EPDM”) or ethylene-octene). Alternatively, modifier polyolefins are also available from Chemtura Corp. under the designation POLYBOND® (e.g., acrylic acid-modified polypropylene) and Eastman Chemical Company under the designation Eastman G series.

As noted above, the polar component can also be incorporated into the polyolefin compatibilizer as a monomer. For example, a (meth)acrylic monomeric component can be employed in certain aspects. As used herein, the term “(meth)acrylic” includes acrylic and methacrylic monomers, as well as salts or esters thereof, such as acrylate and methacrylate monomers. Examples of such (meth)acrylic monomers can include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. Other types of suitable polar monomers include ester monomers, amide monomers, etc.

### E. Other Components

In addition to the components noted above, other additives can also be incorporated into the polymer composition, such as melt stabilizers, processing stabilizers, heat stabilizers, light stabilizers, antioxidants, heat aging stabilizers, whitening agents, bonding agents, fillers, etc. Further, hindered phenols are commonly used as an antioxidant in the production of films. Some suitable hindered phenols include those available from Ciba Specialty Chemicals under the trade name IRGANOX, such as IRGANOX 1076, 1010, or E 201 brand hindered phenols. Moreover, bonding agents can also be added to the film to facilitate bonding of the film to additional materials (e.g., nonwoven webs). Examples of such bonding agents include hydrogenated hydrocarbon resins. Other suitable bonding agents are described in U.S. Pat. No. 4,789,699 to Kieffer et al. and U.S. Pat. No. 5,695,868 to McCormack.

### II. Film Construction

The film of the present disclosure can be mono- or multi-layered. Multilayer films can be prepared by co-extrusion of the layers, extrusion coating, or by any conventional layering process. Such multilayer films normally contain at least one base layer and at least one skin layer, but can contain any number of layers desired. For example, the multilayer film can be formed from a base layer and one or more skin layers. In one aspect, for example, it can be desirable to employ two skin layers that sandwich a base layer. Regardless of the particular construction, the skin and/or base layers can be formed from the polymer composition of the present disclosure. In one aspect, for example, the base layer is formed from the polymer composition of the present disclosure and the skin layer(s) is/are formed from the polymer composition or from an additional polymer material. Likewise, in other possible aspects, one or more of the skin layers are formed from the polymer composition of the present disclosure and the base layer is formed from an additional polymer material. When employed, the additional material can include any type of polymer, such as polyolefins (e.g., polyethylene, polypropylene, etc.), polyesters, polyamides, styrenic copolymers, polyurethanes, polyvinyl acetate, polyvinyl alcohol, etc.

When multiple layers are employed, the base layer typically constitutes a substantial portion of the weight of the film, such as from about 50 wt. % to about 99 wt. %, in some aspects from about 55 wt. % to about 90 wt. %, and in some aspects, from about 60 wt. % to about 85 wt. % of the film. The skin layer(s) can likewise constitute from about 1 wt. % to about 50 wt. %, in some aspects from about 10 wt. % to about 45 wt. %, and in some aspects, from about 15 wt. % to about 40 wt. % of the film. Each skin layer can also have a thickness of from about 0.1 to about 10 micrometers, in some aspects from about 0.5 to about 5 micrometers, and in some aspects, from about 1 to about 2.5 micrometers. Likewise, the base layer can have a thickness of from about from about 1 to about 40 micrometers, in some aspects from about 2 to about 25 micrometers, and in some aspects, from about 5 to about 20 micrometers. As noted above, the total thickness of the film is typically about 50 micrometers or less, in some aspects from about 1 to about 40 micrometers, in some aspects from about 5 to about 35 micrometers, and in some aspects, from about 10 to about 30 micrometers.

Any of a variety of techniques can generally be employed to form the film of the present disclosure. In certain aspects, for example, the components of the film (e.g., ethylene polymer, nanofiller, slip agents, compatibilizer, etc.) can be individually supplied to a film forming system and blended together as the film is being formed. In such cases, the nanofiller can be in the form of a powder containing particles, such as described above. Alternatively, however, it is can be desirable to pre-blend the polymer and nanofiller to form a masterbatch, which is then subsequently supplied to the film forming system. When supplied, the nanofiller can itself be in the form of a masterbatch that can contain nanofiller particles blended with a polymer (e.g., ethylene polymer), or in the form of a powder containing particles.

To form a masterbatch, for example, the components can initially be supplied to twin screw extruder that includes co-rotating screws rotatably mounted and received within a barrel (e.g., cylindrical barrel), which can be heated. The components are moved downstream from a feed end to a discharge end by forces exerted by rotation of the screws. The ratio of the length to outer diameter (“LID”) of the screws can be selected to achieve an optimum balance between throughput and blend uniformity. For example, too large of an L/D value can increase the retention time to such an extent that the nanofiller degrades beyond the desired level or reduce the limit of torque along the twin screw, which can decrease the exfoliation and dispersion of nanofiller. On other hand, too low of an L/D value can not result in the desired degree of blending due to the short residence time. Thus, the L/D value is typically from about 25 to about 60, in some aspects from about 35 to about 55, and in some aspects from about 40 to about 50. The speed of the screws can also be selected to achieve the desired residence time, shear rate, melt processing temperature, etc. Generally, an increase in product temperature is observed with increasing screw speed due to the additional mechanical energy input into the system. The frictional energy results from the shear exerted by the turning screw on the materials within the extruder and results in the fracturing of large molecules. This results in lowering the apparent viscosity and increasing the melt flow rate of the finished material. For example, the screw speed can range from about 50 to about 400 revolutions per minute (“rpm”), in some aspects from about 100 to about 300 rpm, and in some aspects, from about 120 to about 280 rpm. As a result, melt processing can occur at a temperature of from about 100° C. to about 500° C., in some aspects, from about 150° C. to about 350° C., and in some aspects, from about 150° C. to about 300° C. Typically, the apparent shear rate during melt processing can range from about 300 seconds⁻¹ to about 10,000 seconds⁻¹, in some aspects from about 500 seconds⁻¹ to about 5000 seconds⁻¹, and in some aspects, from about 800 seconds⁻¹ to about 1200 seconds⁻¹. The apparent shear rate is equal to 4 Q/□ R³, where Q is the volumetric flow rate (“m³/s”) of the polymer melt and R is the radius (“m”) of the capillary (e.g., extruder die) through which the melted polymer flows. Of course, other variables, such as the residence time during melt processing, which is inversely proportional to throughput rate, can also be controlled to achieve the desired blending.

Any known technique can be used to form a film from the compounded material, including blowing, casting, flat die extruding, etc. In one particular aspect, the film can be formed by a blown process in which a gas (e.g., air) is used to expand a bubble of the extruded polymer blend through an annular die. The bubble is then collapsed and collected in flat film form. Processes for producing blown films are described, for instance, in U.S. Pat. No. 3,354,506 to Raley; U.S. Pat. No. 3,650,649 to Schippers; and U.S. Pat. No. 3,801,429 to Schrenk et al., as well as U.S. Patent Application Publication Nos. 2005/0245162 to McCormack, et al. and 2003/0068951 to Boggs, et al. In yet another aspect, however, the film is formed using a casting technique.

In an exemplary aspect of the present disclosure, a pre-blended masterbatch is supplied to an extruder for melt processing. To help achieve good alignment and orientation of the nanofiller, it is typically desired to use a single screw extruder during film formation. Such single screw extruders are typically divided into three sections along the length of the screw. The first section is a feed section where the solid material is introduced to the screw. The second section is a melting section where a majority of the melting of the solid occurs. Within this section, the screw generally possesses a tapered diameter to enhance melting of the polymer. The third section is the mixing section, which delivers the molten material in a constant amount for extrusion. The L/D ratio for the screw is typically from about 5 to about 50, in some aspects from about 10 to about 40, and in some aspects from about 15 to about 35. Such L/D ratios can be readily achieved in a single screw extruder by using mixing section(s) that constitute only a small portion of the length of the screw. The screw speed can likewise range from about 5 to about 150 rpm, in some aspects from about 10 to about 100 rpm, and in some aspects, from about 20 to about 80 rpm. As a result, melt processing can occur at a temperature of from about 100° C. to about 500° C., in some aspects, from about 150° C. to about 350° C., and in some aspects, from about 150° C. to about 300° C.

Once formed, the extruded material can be immediately chilled and cut into pellet form. The extruded material can be cast onto a casting roll to form a single-layered precursor film. If a multilayered film is to be produced, the multiple layers are co-extruded together onto the casting roll. The casting roll can optionally be provided with embossing elements to impart a pattern to the film. Typically, the casting roll is kept at temperature sufficient to solidify and quench the sheet as it is formed, such as from about 20 to 60° C. If desired, a vacuum box can be positioned adjacent to the casting roll to help keep the precursor film close to the surface of the roll. Additionally, air knives or electrostatic pinners can help force the precursor film against the surface of the casting roll as it moves around a spinning roll. An air knife is a device known in the art that focuses a stream of air at a very high flow rate to pin the edges of the film.

Once cast, the film can then be optionally oriented in one or more directions to further improve film uniformity and reduce thickness. In the case of sequential orientation, the “softened” film is drawn by rolls rotating at different speeds of rotation such that the sheet is stretched to the desired draw ratio in the longitudinal direction (machine direction). If desired, the uniaxially oriented film can also be oriented in the cross-machine direction to form a “biaxially oriented” film. For example, the film can be clamped at its lateral edges by chain clips and conveyed into a tenter oven. In the tenter oven, the film can be reheated and drawn in the cross-machine direction to the desired draw ratio by chain clips diverged in their forward travel.

In one method for forming a uniaxially oriented film, a precursor film is directed to a film-orientation unit or machine direction orienter (“MDO”), such as commercially available from Marshall and Willams, Co. of Providence, R.I. The MDO has a plurality of stretching rolls that progressively stretch and thin the film in the machine direction, which is the direction of travel of the film through the process. It should be understood that the number of rolls in the MDO can vary depending on the level of stretch that is desired and the degrees of stretching between each roll. The film can be stretched in either single or multiple discrete stretching operations. It should be noted that some of the rolls in an MDO apparatus cannot be operating at progressively higher speeds. If desired, some of the rolls of the MDO can act as preheat rolls. If present, these first few rolls heat the film above room temperature. The progressively faster speeds of adjacent rolls in the MDO act to stretch the film. The rate at which the stretch rolls rotate determines the amount of stretch in the film and final film weight. The resulting film can then be wound and stored on a take-up roll. Various additional potential processing and/or finishing steps known in the art, such as embossing, slitting, treating, aperturing, printing graphics, or lamination of the film with other layers (e.g., nonwoven web materials), can be performed without departing from the spirit and scope of the disclosure.

In one aspect, for example, the film can be embossed using any technique known in the art to form a pattern of embossed regions on one or more surfaces of the film. Suitable techniques include, for instance, the use of raised elements to impart the desired embossing pattern. Thermal and/or ultrasonic bonding techniques can be employed. For instance, a suitable process can involve thermal bonding wherein a layer is passed through two rolls (e.g., steel, rubber, etc.) in which one is engraved with an embossing pattern and the other is flat. One or both of the rolls can be heated. Regardless of the technique employed, the resulting embossed regions can have a relatively small depth such that the film is considered “micro-embossed.” Micro-embossed films can, for instance, have embossed regions with a depth of from about 5 micrometers or less, and in some aspects, from about 1 to about 4 micrometers. Of course, the embossed regions can also have a relatively large depth such that the film is considered “deep embossed.” Such films can, for instance, have embossed regions with a depth of greater than about 5 micrometers, and in some aspects, from about 5 to about 20 micrometers.

It should be understood that other configurations are also included within the scope of the present disclosure. In addition, the present disclosure is by no means limited to any particular type of packaging or contents. In fact, any suitable type of packaging can be formed in accordance with the present disclosure. The film can also be used in other applications as well.

### Examples

The present disclosure can be better understood with reference to the following examples.

A Haake film extruder and an analytical laboratory were used to evaluate clay concentrates with various slip materials known in the industry. COF was determined using ASTM D1894, “Standard Test Method for Static and Kinetic Coefficients of Friction of Plastic Film and Sheeting.” COF data generated were analyzed; one slip additive appeared to work best: AMPACET 102109 brand secondary amide slip concentrate, which was further evaluated by itself and blended with a standard primary erucamide (standard slip agent), AMPACET 10090 brand primary amide slip concentrate, which is 5 to 5.5% erucamide in LDPE. COFs were recorded and evaluated. It is also notable that there is a regulatory limit of 3000 ppm on some secondary amide slip concentrates in packaging films, which is insufficient to achieve the necessary COF.

Experimentation found five materials that met the COF requirement of 0.20 target and 0.25 maximum for both static and kinetic COF as well as inside to inside and outside to outside COFs. Further selection was done via physical properties, including tensile strength at break in both MD (machine direction) and CD (cross direction), MD & CD 1% secant modulus (stiffness), dart impact, MD & CD elongation (peak stress), Elmendorf tear resistance, WVTR and OTR barriers, etc. Initial comparisons indicated the organoclay percentage should be around 5% by weight of the overall structure for maximum performance. The total clay percentage is affected if the clay is restricted to only 2 of the 3 layers, avoiding the sealant layer for two reasons. One, the clay could affect heat seal properties, either positively or negatively. Two, maintaining a functional barrier of virgin polymeric material on the product or sealant surface is known to speed product safety clearances.

To solve the COF issue, commercially available materials were purchased and screened. The AMPACET brand secondary amide slip additive was selected to be used for the organoclay packaging films. It was used in conjunction with the standard primary erucamide slip agent to ensure the 0.25 COF was achieved and maintained. The secondary amide slip blooms more slowly than the primary erucamide slip material, but also settles and holds its position on the surface of the film. Using additional primary erucamide slip, the team was able to reduce the surface COFs to 0.25 and meet current COF specifications for packaging.

Five exemplary multi-layer films were produced according to the specifications in Table 1. Each film included a core or base layer, an inner or skin layer (typically product-facing), and an outer or skin layer (typically shelf-facing). In each case, the inner layer is 15 percent of the thickness, the outer layer is 15 percent of the thickness, and the core or base layer is 70 percent of the thickness.

In Table 1, “Master Blend” has as its components 87% NOVA FP120A brand octene LLDPE, 1.0 Ml, 0.920 g/cm3; 9% BYK CLAYTONE HY brand clay powder, 1.6 g/cm3; and 4% DuPont E 528D FUSABOND brand compatibilizer, 6.7 Ml, 0.922 g/cm3. The amount of clay resident in the Master Blend is selected such that the concentration of clay in the final film is about 5%. “Nova FP120A” is NOVA FP120A brand octene LLDPE, 1.0 Ml, 0.920 g/cm3. “LD306.57” is EXXONMOBIL LD306.57 brand low density polyethylene. “Dow 5960G” is DOW 5960G brand high density polyethylene. “Ampacet 111017P” is AMPACET 111017P brand white colorant. “Polyfil ABC5000” is POLYFIL ABC5000 brand anti-blocking agent. “Ampacet 10090” is AMPACET 10090 brand primary erucamide slip concentrate. “Ampacet 102109” is AMPACET 102109 brand secondary amide slip concentrate.

The Tag A film includes organoclay in its core layer, but has no organoclay in its skins. The Tag B film is similar to the Tag A film but adds organoclay to its outer skin layer. The Tag C film is similar to the Tag B film but adds a secondary amide slip agent to both skin layers. The Tag D film is similar to the Tag C film but doubles the amount of secondary amide slip agent in both skin layers. The Tag E film is similar to the Tag D film but significantly increases the amount of primary erucamide slip agent added to the core layer.

TABLE 1
Film Structure and Composition

| Tag | Outer Layer | Core Layer | Inner Layer |
|---|---|---|---|
| A | 15% | 70% | 15% |
| | 58% Nova FP120A | 44% Master Blend | 58% Nova FP120A |
| | 32% LD306.57 | 30% Dow 5960G | 32% LD306.57 |
| | 8% Ampacet 10090 | 10% Ampacet 10090 | 8% Ampacet 10090 |
| | 2% Polyfil ABC5000 | 16% Ampacet 111017P | 2% Polyfil ABC5000 |
| B | 15% | 70% | 15% |
| | 57.5% Master Blend | 44% Master Blend | 58% Nova FP120A |
| | 32.5% LD306.57 | 30% Dow 5960G | 32% LD306.57 |
| | 8% Ampacet 10090 | 10% Ampacet 10090 | 8% Ampacet 10090 |
| | 2% Polyfil ABC5000 | 16% Ampacet 111017P | 2% Polyfil ABC5000 |
| C | 15% | 70% | 15% |
| | 54.5% Master Blend | 44% Master Blend | 54.5% Nova FP120A |
| | 32.5% LD306.57 | 30% Dow 5960G | 32.5% LD306.57 |
| | 3% Ampacet 102109 | 10% Ampacet 10090 | 3% Ampacet 102109 |
| | 8% Ampacet 10090 | 16% Ampacet 111017P | 8% Ampacet 10090 |
| | 2% Polyfil ABC5000 | | 2% Polyfil ABC5000 |
| D | 15% | 70% | 15% |
| | 53% Master Blend | 44% Master Blend | 53% Nova FP120A |
| | 31% LD306.57 | 30% Dow 5960G | 31% LD306.57 |
| | 6% Ampacet 102109 | 10% Ampacet 10090 | 6% Ampacet 102109 |
| | 8% Ampacet 10090 | 16% Ampacet 111017P | 8% Ampacet 10090 |
| | 2% Polyfil ABC5000 | | 2% Polyfil ABC5000 |
| E | 15% | 70% | 15% |
| | 53% Master Blend | 40.5% Master Blend | 53% Nova FP120A |
| | 31% LD306.57 | 26.5% Dow 5960G | 31% LD306.57 |
| | 6% Ampacet 102109 | 17% Ampacet 10090 | 6% Ampacet 102109 |
| | 8% Ampacet 10090 | 16% Ampacet 111017P | 8% Ampacet 10090 |
| | 2% Polyfil ABC5000 | | 2% Polyfil ABC5000 |

The results of testing the COFs of the films described above are presented in Table 2. The “Inside” results are those of testing the COFs of the inner skin layers, as one might encounter in placing a product into a package made from the film. The “Outside” results are those of testing the COFs of the outer skin layers, as one might encounter between a package made from the film and a shelf or carton in contact with the package. The average and standard deviation for static and kinetic COFs are shown. The first group of Tags A-α are the COFs for the films after they are manufactured, at T=0. The second group of Tags A-α are the COFs for the films after they have been stored for one week (T=1 week), after the slip agents have had a chance to bloom as described above.

TABLE 2
COF Results of Multi-layer Films Including Organoclays

| | Inside | | | | Outside | | | |
|---|---|---|---|---|---|---|---|---|
| | Static | | Kinetic | | Static | | Kinetic | |
| Tag | Avg | STD | Avg | STD | Avg | STD | Avg | STD |

Time = 0

| | | | | | | | | |
|---|---|---|---|---|---|---|---|---|
| A | 0.143 | 0.013 | 0.133 | 0.002 | 0.218 | 0.003 | 0.195 | 0.008 |
| B | 0.120 | 0.000 | 0.120 | 0.001 | 0.422 | 0.018 | 0.364 | 0.003 |
| C | 0.130 | 0.005 | 0.128 | 0.003 | 0.303 | 0.028 | 0.281 | 0.005 |
| D | 0.115 | 0.005 | 0.118 | 0.004 | 0.290 | 0.035 | 0.256 | 0.002 |
| E | 0.115 | 0.000 | 0.114 | 0.001 | 0.348 | 0.084 | 0.262 | 0.020 |

Time = 1 week

| | | | | | | | | |
|---|---|---|---|---|---|---|---|---|
| A | 0.132 | 0.003 | 0.126 | 0.001 | 0.142 | 0.003 | 0.127 | 0.002 |
| B | 0.128 | 0.003 | 0.122 | 0.000 | 0.408 | 0.035 | 0.361 | 0.002 |
| C | 0.138 | 0.015 | 0.132 | 0.007 | 0.175 | 0.000 | 0.167 | 0.003 |
| D | 0.125 | 0.005 | 0.122 | 0.001 | 0.155 | 0.000 | 0.152 | 0.001 |
| E | 0.127 | 0.012 | 0.120 | 0.001 | 0.155 | 0.005 | 0.140 | 0.005 |

As shown in Table 2, the Tag A film with no organoclay and only a primary erucamide slip agent in its skin layers demonstrates acceptable COF results (below 0.25) for static and kinetic COFs on its inside and outside, both at the time of manufacture and one week later. Simply adding organoclay to the outer layer of the Tag A film to produce the Tag B film, however, results in a significant and unacceptable increase in both the static and kinetic COFs of the outside of Film B. It should be noted that the COFs of the inside layer of the Tag B film remain acceptable because organoclay was not added to the inside layer.

To correct this increase in COF, a secondary amide slip agent is added to the outside layer of the Tag B film to produce the Tag C film. The Tag C film has outside COFs that are outside the goal of 0.25 upon manufacture, but that are easily within the goal after only a week once the slip agents have had a chance to bloom. Doubling the amount of secondary amide slip agent in the outer layer for the Tag D film does not significantly affect the COFs as compared to the Tag C film, demonstrating that COF is dependent on more than just the amount of slip agent added. This lack of direct correlation shows that there is a synergistic effect in the combination of primary and secondary amide slip agents in the film. Adding a significant amount of primary amide slip agent to the core layer of the Tag E film in an attempt to create a reservoir of slip agent also does not significantly affect the COFs of the film as compared to the Tag D film. Again, the COF is not directly dependent on the amount of slip agent added, but is highly affected by the synergistic combination of slip agents.

In a first particular aspect, a film includes a polymer composition, the polymer composition including a polymer, an organoclay, a primary amide slip agent, and a secondary amide slip agent different from the primary amide slip agent.

A second particular aspect includes the first particular aspect, wherein the polymer is a polyolefin.

A third particular aspect includes the first and/or second aspect, wherein the polyolefin is polyethylene.

A fourth particular aspect includes one or more of aspects 1-3, wherein the polymer includes one or more ethylene polymers in an amount of from about 75 wt. % to about 99 wt. % of the polymer composition.

A fifth particular aspect includes one or more of aspects 1-4, wherein the organoclay is in an amount of from about 0.5 wt. % to about 20 wt. % of the polymer composition.

A sixth particular aspect includes one or more of aspects 1-5, wherein the primary amide slip agent has an addition rate of about 3 wt. % to about 10 wt. %.

A seventh particular aspect includes one or more of aspects 1-6, wherein the secondary amide slip agent has an addition rate of about 2 wt. % to about 8 wt. %.

An eighth particular aspect includes one or more of aspects 1-7, further comprising a base layer, wherein the polymer composition is in the base layer.

A ninth particular aspect includes one or more of aspects 1-8, further comprising a first skin layer affixed to the base layer.

A tenth particular aspect includes one or more of aspects 1-9, further comprising a second skin layer affixed to the base layer opposite to the first skin layer.

An eleventh particular aspect includes one or more of aspects 1-10, further comprising a base layer and a first skin layer, wherein the polymer composition is in one of the base layer and the first skin layer.

A twelfth particular aspect includes one or more of aspects 1-11, further comprising a base layer, a first skin layer, and a second skin layer, wherein the polymer composition is in one of the base layer, the first skin layer, and the second skin layer.

A thirteenth particular aspect includes one or more of aspects 1-12, wherein.

A fourteenth particular aspect includes one or more of aspects 1-13, wherein the primary amide slip agent is a primary erucamide slip agent.

In a fifteenth particular aspect, a film includes a polymer composition, the polymer composition including a polymer, an organoclay, a primary amide slip agent, and a secondary amide slip agent, wherein the film has static and kinetic coefficients of friction less than 0.25 as measured using ASTM D1894.

A sixteenth particular aspect includes the fifteenth particular aspect, wherein the primary amide slip agent is a primary erucamide slip agent.

A seventeenth particular aspect includes the fifteenth and/or sixteenth aspects, further comprising a base layer, a first skin layer, and a second skin layer, wherein the polymer composition is in one of the base layer, the first skin layer, and the second skin layer.

An eighteenth particular aspect includes one or more of aspects 15-17, wherein the polymer is polyethylene.

A nineteenth particular aspect includes one or more of aspects 15-18, wherein the organoclay is in an amount of from about 0.5 wt. % to about 20 wt. % of the polymer composition.

In a twentieth particular aspect, a film includes a polymer composition, the polymer composition including a polymer, an organoclay, a primary erucamide slip agent, and a secondary amide slip agent

While the disclosure has been described in detail with respect to the specific aspects thereof, it will be appreciated that those skilled in the art, upon attaining an understanding of the foregoing, can readily conceive of alterations to, variations of, and equivalents to these aspects. Accordingly, the scope of the present disclosure should be assessed as that of the appended claims and any equivalents thereto.

What is claimed is:

1. A film comprising a polymer composition, the polymer composition including a polymer, an organoclay, a primary amide slip agent, and a secondary amide slip agent different from the primary amide slip agent.

2. The film of claim 1, wherein the polymer is a polyolefin.

3. The film of claim 2, wherein the polyolefin is polyethylene.

4. The film of claim 1, wherein the polymer includes one or more ethylene polymers in an amount of from about 75 wt. % to about 99 wt. % of the polymer composition.

5. The film of claim 1, wherein the organoclay is in an amount of from about 0.5 wt. % to about 20 wt. % of the polymer composition.

6. The film of claim 1, wherein the primary amide slip agent has an addition rate of about 3 wt. % to about 10 wt. %.

7. The film of claim 1, wherein the secondary amide slip agent has an addition rate of about 2 wt. % to about 8 wt. %.

8. The film of claim 1, further comprising a base layer, wherein the polymer composition is in the base layer.

9. The film of claim 8, further comprising a first skin layer affixed to the base layer.

10. The film of claim 9, further comprising a second skin layer affixed to the base layer opposite to the first skin layer.

11. The film of claim 1, further comprising a base layer and a first skin layer, wherein the polymer composition is in one of the base layer and the first skin layer.

12. The film of claim 1, further comprising a base layer, a first skin layer, and a second skin layer, wherein the polymer composition is in one of the base layer, the first skin layer, and the second skin layer.

13. The film of claim 1, wherein the primary amide slip agent has a concentration of at least 6 wt. % and the secondary amide slip agent has a concentration of at least 3 wt. %.

14. The film of claim 1, wherein the primary amide slip agent is a primary erucamide slip agent.

15. A film comprising a polymer composition, the polymer composition including a polymer, an organoclay, a primary amide slip agent, and a secondary amide slip agent, wherein the film has static and kinetic coefficients of friction less than 0.25 as measured using ASTM D1894.

16. The film of claim 15, wherein the primary amide slip agent is a primary erucamide slip agent.

17. The film of claim 15, further comprising a base layer, a first skin layer, and a second skin layer, wherein the polymer composition is in one of the base layer, the first skin layer, and the second skin layer.

18. The film of claim 15, wherein the polymer is polyethylene.

19. The film of claim 15, wherein the organoclay is in an amount of from about 0.5 wt. % to about 20 wt. % of the polymer composition.

20. A film comprising a polymer composition, the polymer composition including a polymer, an organoclay, a primary erucamide slip agent, and a secondary amide slip agent.
